(19) United States
(12) Patent Application Publication
(10) Pub. No.: US 2026/0281215 A1
(43) Pub. Date: Sep. 17, 2026

(54) SIGNALING DESIGNS ENABLING UNEQUAL MODULATION TRANSMISSION ON SPATIAL STREAMS IN WIRELESS COMMUNICATIONS

(71) Applicant: MEDIATEK INC., Hsinchu City (TW)

(72) Inventors: Shengquan HU, San Jose, CA (US); Jianhan LIU, San Jose, CA (US); You-Wei CHEN, San Jose, CA (US); Thomas Edward PARE, JR., San Jose, CA (US)

(21) Appl. No.: 19/168,292

(22) PCT Filed: Dec. 12, 2024
(86) PCT No.: PCT/CN2024/138773

§ 371 Date: Sep. 23, 2025

Related U.S. Application Data
(60) Provisional application No. 63/608,895, filed on Dec. 12, 2023.

(51) Int. Cl. H04L 69/323; H04B 7/0452; H04L 27/20

(52) U.S. Cl. CPC H04L 69/323; H04B 7/0452; H04L 27/2082

(57) ABSTRACT

Techniques pertaining to signaling designs to enable unequal modulation (UEQM) transmission on spatial streams in wireless communications are described. An apparatus (e.g., a station (STA)) performs a wireless communication with a physical-layer protocol data unit (PPDU) by either: (a) generating and transmitting the PPDU; or (b) receiving and processing the PPDU. The wireless communication is performed with signaling indicating information of the UEQM over multiple spatial streams with respect to a transmission of the PPDU.

### CROSS REFERENCE TO RELATED PATENT APPLICATION

The present disclosure is part of a non-provisional patent application claiming the priority benefit of U.S. Provisional Patent Application No. 63/608,895 filed 12 Dec. 2023, the content of which herein being incorporated by reference in its entirety.

### TECHNICAL FIELD

The present disclosure is generally related to wireless communications and, more particularly, to signaling designs to enable unequal modulation (UEQM) transmission on spatial streams in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) in WLAN systems in accordance with the Institute of Electrical and Electronics Engineers (IEEE) 802.11 standards, multi-input-multi-output (MIMO) channel condition number (CN) can be as high as somewhere in the range of 10 dB~15 dB. Assigning different modulation levels across multiple spatial streams can significantly improve overall system throughput. Accordingly, UEQM with joint encoding (e.g., with the same code rate but different modulation levels across different spatial streams) may be utilized to achieve system throughput gain yet with less implementation complexity. However, detailed designs of UEQM with joint encoding have not been specified at the time of the present disclosure. Therefore, there is a need for a solution for signaling designs to enable UEQM transmission on spatial streams in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to signaling designs to enable UEQM transmission on spatial streams in wireless communications. It is believed that implementations of various schemes proposed herein may address or otherwise alleviate the aforementioned issues.

In one aspect, a method may involve performing a wireless communication with a physical-layer protocol data unit (PPDU) by either: (a) generating and transmitting the PPDU; or (b) receiving and processing the PPDU. The wireless communication may be performed with signaling indicating information of the UEQM over multiple spatial streams with respect to a transmission of the PPDU.

In another aspect, an apparatus may include a transceiver configured to communicate wirelessly and a processor coupled to the transceiver. The processor may perform a wireless communication with a PPDU by either: (a) generating and transmitting the PPDU; or (b) receiving and processing the PPDU. The wireless communication may be performed with signaling indicating information of the UEQM over multiple spatial streams with respect to a transmission of the PPDU.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7A and FIG. 7B each is a diagram of an example design under a proposed scheme in accordance with the present disclosure.

FIG. 8 is a diagram of an example design under a proposed scheme in accordance with the present disclosure.

FIG. 9 is a diagram of an example design under a proposed scheme in accordance with the present disclosure.

FIG. 10 is a diagram of an example design under a proposed scheme in accordance with the present disclosure.

FIG. 11 is a diagram of an example design under a proposed scheme in accordance with the present disclosure.

FIG. 12 is a diagram of an example design under a proposed scheme in accordance with the present disclosure.

FIG. 13 is a diagram of an example design under a proposed scheme in accordance with the present disclosure.

FIG. 14 is a diagram of an example design under a proposed scheme in accordance with the present disclosure.

FIG. 15 is a diagram of an example design under a proposed scheme in accordance with the present disclosure.

FIG. 16 is a diagram of an example design under a proposed scheme in accordance with the present disclosure.

FIG. 17 is a diagram of an example design under a proposed scheme in accordance with the present disclosure.

FIG. 18 is a diagram of an example design under a proposed scheme in accordance with the present disclosure.

FIG. 19 is a block diagram of an example communication system in accordance with an implementation of the present disclosure.

FIG. 20 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to signaling designs to enable UEQM transmission on spatial streams in wireless communications. According to the present disclosure, a number of possible solutions may be implemented separately or jointly. That is, although these possible solutions may be described below separately, two or more of these possible solutions may be implemented in one combination or another.

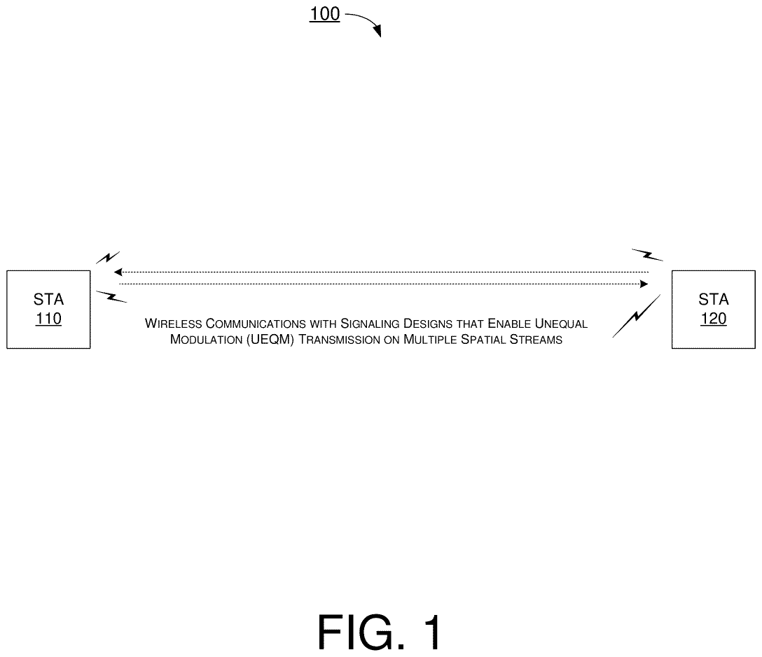

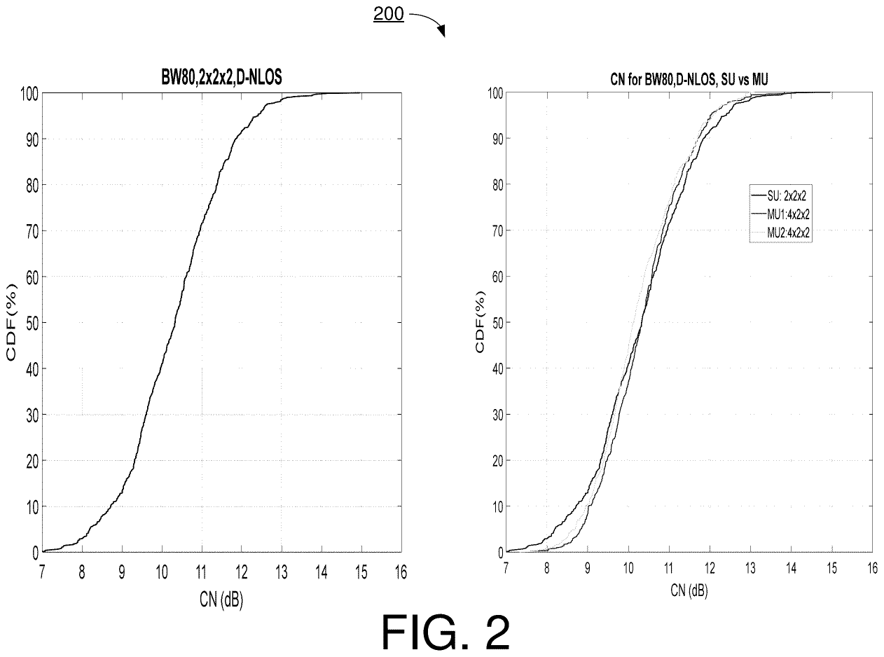

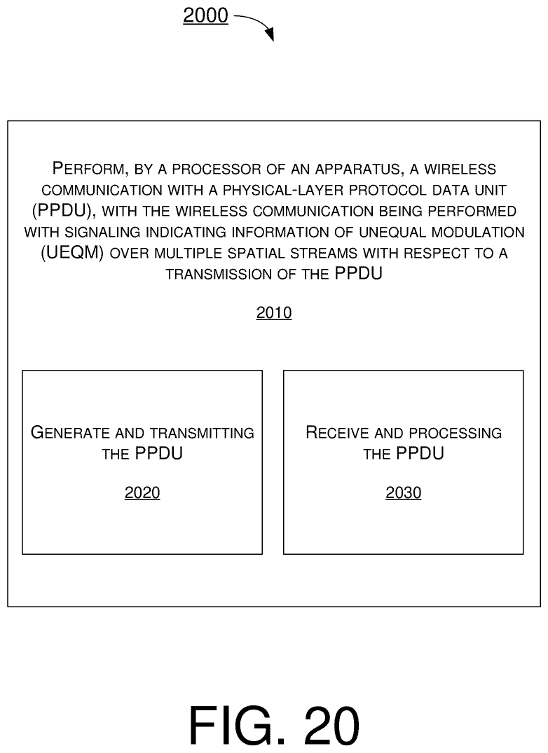

FIG. 1 illustrates an example network environment 100 in which various solutions and schemes in accordance with the present disclosure may be implemented. FIG. 2~FIG. 20 illustrate examples of implementation of various proposed schemes in network environment 100 in accordance with the present disclosure. The following description of various proposed schemes is provided with reference to FIG. 1~FIG. 20.

Referring to part (A) of FIG. 1, network environment 100 may involve at least a station (STA) 110 communicating wirelessly with a STA 120. Either of STA 110 and STA 120 may function as an access point (AP) STA or, alternatively, a non-AP STA. In some cases, STA 110 and STA 120 may be associated with a basic service set (BSS) in accordance with one or more IEEE 802.11 standards (e.g., IEEE 802.11bn and future-developed standards). Each of STA 110 and STA 120 may be configured to communicate with each other by utilizing the signaling designs to enable UEQM transmission on spatial streams in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 of MIMO channel condition number in which various proposed schemes in accordance with which the present disclosure may be implemented. Referring to FIG. 2, the graphs show CNs for single-user MIMO (SU-MIMO) and multi-user MIMO (MU-MIMO). For example, the CN of a MU-MIMO user with a 4×2×2 (4 transmitter antennas, 2 receiver antennas, 2 spatial streams per user) configuration may have a similar CN as that of a SU-MIMO with the configuration of 2×2×2 (2 transmitter antennas, 2 receiver antennas, 2 spatial streams). Under the proposed schemes, UEQM transmission may be applied on both SU-MIMO and MU-MIMO transmissions.

Under a proposed scheme in accordance with the present disclosure, there may be different operation modes of UEQM on spatial streams (SS). For instance, UEQM on SS may be operated with one or more of the below-described modes. A first mode may be downlink/uplink (DL/UL) SU-MIMO with two spatial streams (2SS), three spatial streams (3SS) and four spatial streams (4SS), or other configurations with SS>1. A second mode may be DL non-orthogonal frequency-division multiple-access (non-OFDMA) MU-MIMO for a user with a number of SS>1 (e.g., 2SS, 3SS, 4SS, and so on). A third mode may be DL orthogonal frequency-division multiple-access (OFDMA) non-MU-MIMO for a user on an assigned resource unit (RU) and/or multi-RU (MRU) but with MIMO transmission. A fourth mode may be DL OFDMA MU-MIMO for a user with an assigned number of spatial streams>1 (e.g., 2SS, 3SS, 4SS, and so on). A fifth mode may be UL trigger-based (TB) physical-layer protocol data unit (PPDU) with: (1) non-OFDMA MU-MIMO for a user with a number of spatial streams>1 (e.g., 2SS, 3SS, 4SS, and so on); (2) OFDMA non-MU-MIMO for a user on an assigned RU/MRU but with MIMO transmission; and (3) OFDMA MU-MIMO for a user with an assigned number of spatial streams>1 (e.g., 2SS, 3SS, 4SS, and so on). It is noteworthy that the above-listed SU-MIMO/OFDMA non-MU-MIMO operations may involve either beamforming or non-beamforming. Under the proposed scheme, a flexible signaling method, as described below, may be utilized to enable the above-listed operation modes of UEQM transmissions on SS (UEQM on SS).

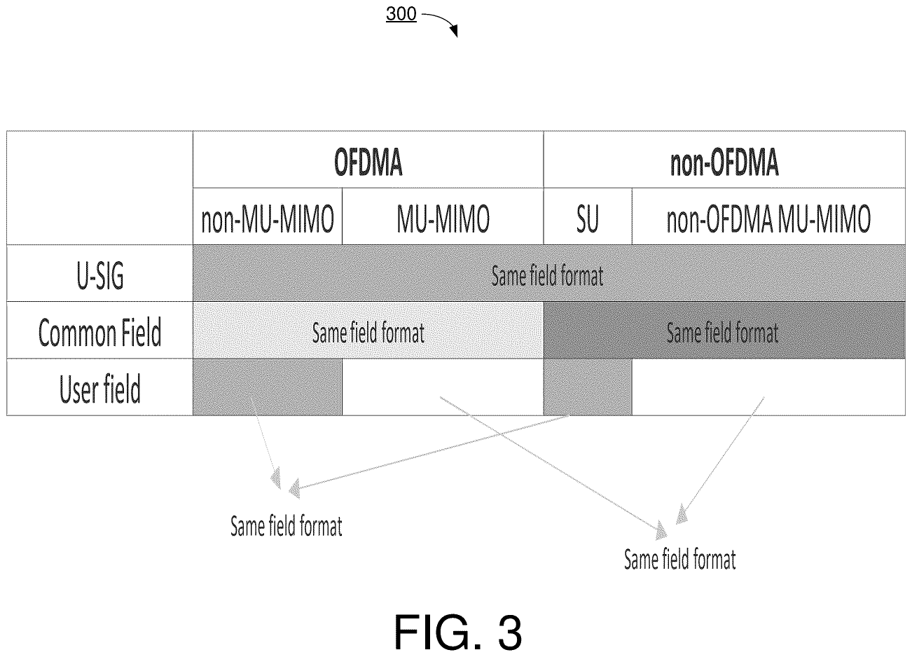

FIG. 3 illustrates an example design 300 under a proposed scheme in accordance with the present disclosure. Design 300 may pertain to a signaling design for IEEE 802.11bn (or Wi-Fi 8). Under the proposed scheme, it may be assumed that the IEEE 802.11bn specification may keep a PPDU format similar to that as defined in the IEEE 802.11be specification, which may include Ultra-High-Reliable (UHR) MU PPDU and UHR TB PPDU. Under the proposed scheme, an Extremely-High-Throughput (EHT) (or UHR) MU PPDU may be utilized for DL OFDMA (including non-MU-MIMO and MU-MIMO), DL SU, DL non-OFDMA MU-MIMO and DL null data packet (NDP) sounding transmissions.

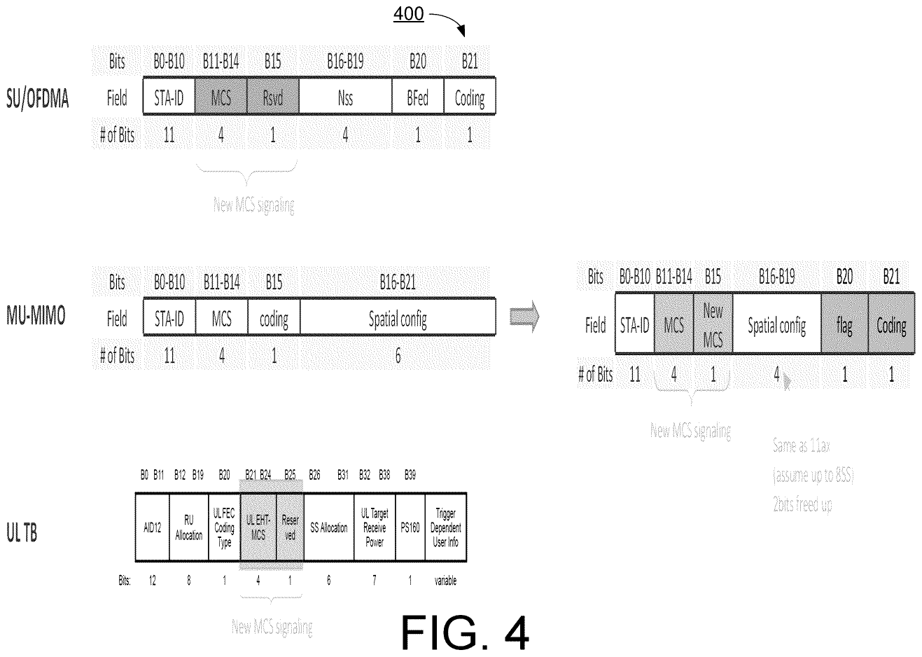

FIG. 4 illustrates an example design 400 under a proposed scheme in accordance with the present disclosure. Design 400 may pertain to new modulation and coding scheme (MCS) signaling. Under the proposed scheme, a number of new MCS levels may be added and utilized in wireless communications in accordance with IEEE 802.11bn specification and future-developed specifications and standards. These new MCS levels may include, for example and not limited to, binary phase shift keying (BPSK)+2/3 coding rate, quadrature phase shift keying (QPSK)+2/3 coding rate, 16 quadrature amplitude modulation (16QAM)+2/3 coding rate, 16QAM+5/6 coding rate, 256QAM+2/3 coding rate, and 4096QAM+7/8 coding rate. Moreover, new MCS indexes (or indices) may be defined for equal modulation (EQM) transmissions. Under the proposed scheme, a subset of the new MCS levels of EQM transmissions may also be used for UEQM transmissions. Furthermore, under the proposed scheme, a total of 5 bits in User field or User Info field may be utilized to indicate MCS (including new MCS levels) in a User field of a PPDU, as shown in FIG. 4. For instance, for a SU/OFDMA transmission, the five bits of bits B11~B15, corresponding to the MCS subfield and Reserved subfield in a User field of a PPDU, may be utilized to indicate the MCS level (among existing and new MCS levels). Additionally, one extra bit, such as bit B22, may be utilized for 2xLDPC indication. For a MU-MIMO transmission, the five bits of bits B11~B15 in User field, corresponding to the MCS subfield and a New MCS subfield in a User field of a PPDU, may be utilized to indicate the MCS level (among existing and new MCS levels). Moreover, one extra bit, such as bit B22, may be utilized for 2xLDPC indication. For a UL TB transmission, the five bits of bits B21~B25, corresponding to the UL EHT-MCS subfield and Reserved subfield in a User Info field of a PPDU, may be utilized to indicate the MCS level (among existing and new MCS levels).

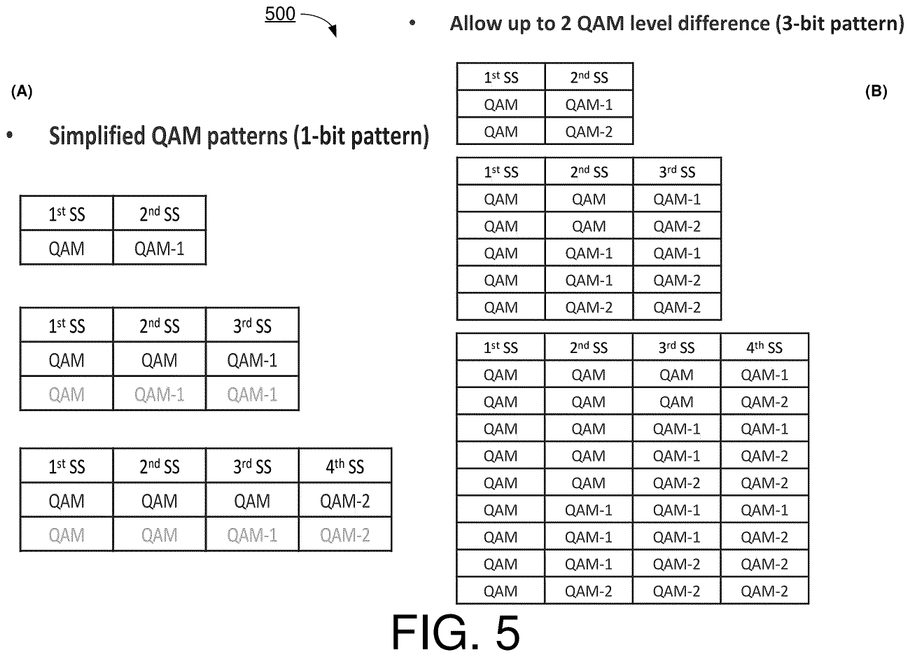

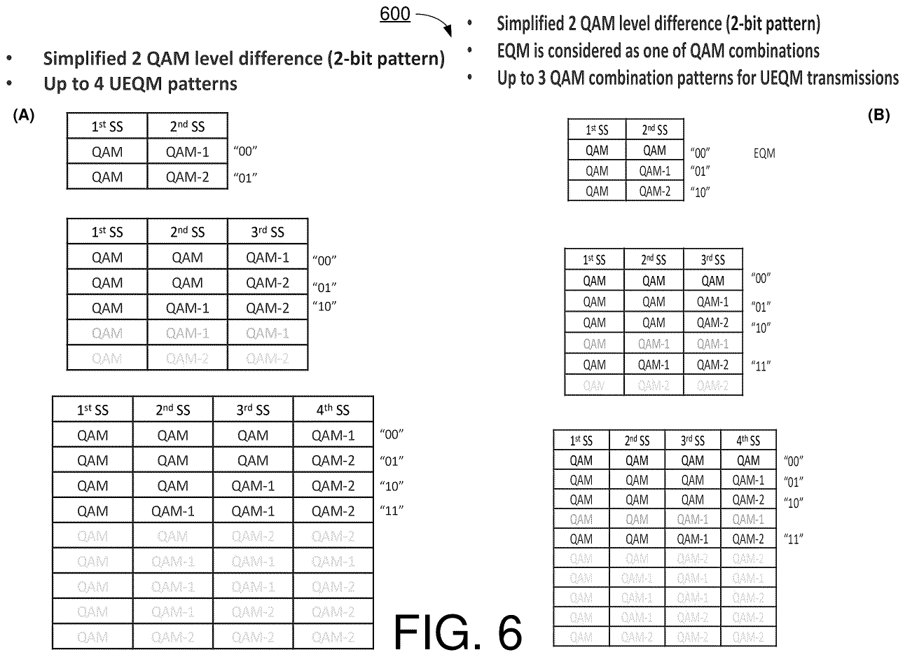

Under a proposed scheme in accordance with the present disclosure, there may be certain signaling designs for UEQM on SS. For instance, there may be a need to indicate whether or not UEQM is enabled as well as a UEQM pattern over one or more spatial streams. It may be assumed that UEQM on SS may be operated for a number of modes, including and not limited to: SU (for DL and UL), DL OFDMA, DL MU-MIMO, and UL TB transmissions. The UEQM patterns for UEQM on SS may be summarized in FIG. 5 and FIG. 6 as described below. For different QAM/UEQM pattern options, different number of bits may be utilized to indicate UEQM transmissions such as, for example and without limitation, 1 bit for a simple pattern, 2 bits for a simplified UEQM pattern, and 3 bits for up to a 2-QAM level difference. Under the proposed scheme, the UEQM signaling may be per-user and may be included in the User field, and it may be assumed that coding and decoding of PPDUs in UEQM transmissions may be performed only with low-density parity-check (LDPC). The MCS in a UHR signaling (UHR SIG) User field in a PPDU may be utilized to indicate the MCS (both QAM and coding rate) used in a first SS (1^{st} SS). Other streams (e.g., the 2^{nd} SS, 3^{rd} SS or 4^{th} SS) may refer to the 1^{st} SS, with the modulation (or QAM) level being 0-level or 1-level or 2-level down (or lower), but the coding rate may be the same as that of the 1^{st} SS.

FIG. 5 illustrates an example design 500 under a proposed scheme in accordance with the present disclosure. Design 500 may pertain to UEQM combination patterns for UEQM on SS. Part (A) of FIG. 5 shows an example design for simplified UEQM patterns (e.g., 1-bit pattern). Part (B) of FIG. 5 shows an example design for up to a 2-QAM level difference (e.g., 3-bit pattern). Under the proposed scheme, the MCS (e.g., 5 bits) value in the UHR-SIG User field may indicate the MCS (both QAM and coding rate) may be used in the 1^{st} SS (or the spatial stream with the strongest signal quality). Other streams (e.g., 2^{nd} SS, 3^{rd} SS or 4^{th} SS) may refer to the 1^{st} SS, with the modulation (or QAM) level being 0-level or 1-level or 2-level down (or lower), but the coding rate may be the same as that of the 1^{st} SS. In FIG. 5, with the modulation level of the 1^{st} SS indicated as “QAM”, a same-level modulation relative to that of the 1^{st} SS (as the reference) may be indicated as “QAM”, a 1-level down (or lower) in modulation relative to that of the 1^{st} SS (as the reference) may be indicated as “QAM-1”, and a 2-level down (or lower) in modulation relative to that of the 1^{st} SS (as the reference) may be indicated as “QAM-2”.

FIG. 6 illustrates an example design 600 under a proposed scheme in accordance with the present disclosure. Design 600 may pertain to UEQM patterns for UEQM on SS. Part (A) of FIG. 6 shows an example design for simplified UEQM patterns with a 2-QAM level difference (e.g., 2-bit pattern). There may be up to four UEQM patterns. For instance, the two bits may have a value of “00”, “01”, “10” or “11” to represent corresponding QAM levels. Part (B) of FIG. 6 shows an example design for simplified UEQM patterns with a 2-QAM level difference (e.g., 2-bit pattern). For instance, the two bits may have a value of “00”, “01”, “10” or “11” to represent corresponding UEQM patterns. EQM may be considered as one of UEQM/QAM combination patterns. There may be up to three UEQM patterns for UEQM transmissions. In FIG. 6, with the modulation level of the 1^{st} SS indicated as “QAM”, a same-level modulation relative to that of the 1^{st} SS (as the reference) may be indicated as “QAM”, a 1-level down (or lower) in modulation relative to that of the 1^{st} SS (as the reference) may be indicated as “QAM-1”, and a 2-level down (or lower) in modulation relative to that of the 1^{st} SS (as the reference) may be indicated as “QAM-2”.

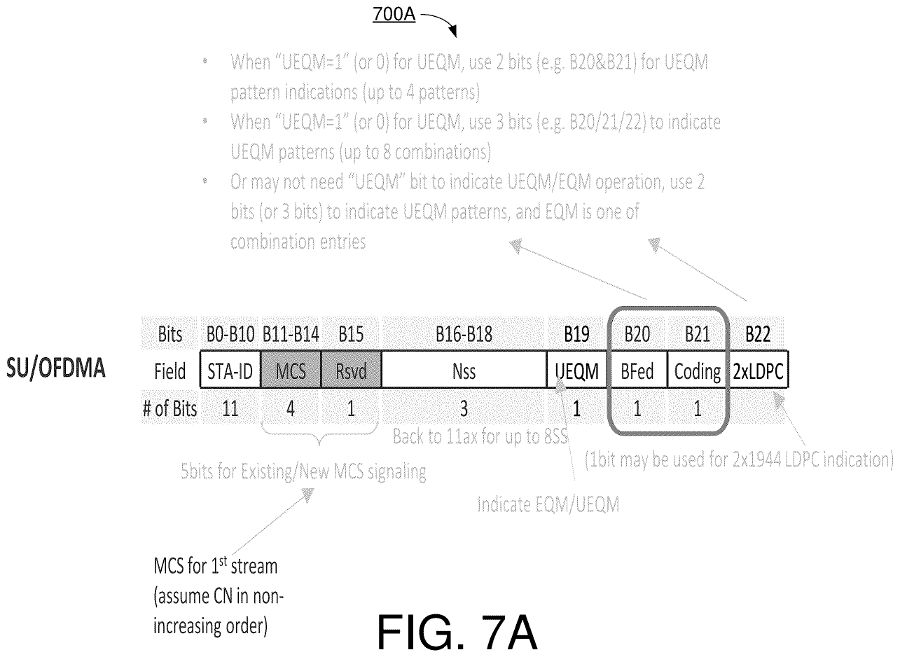

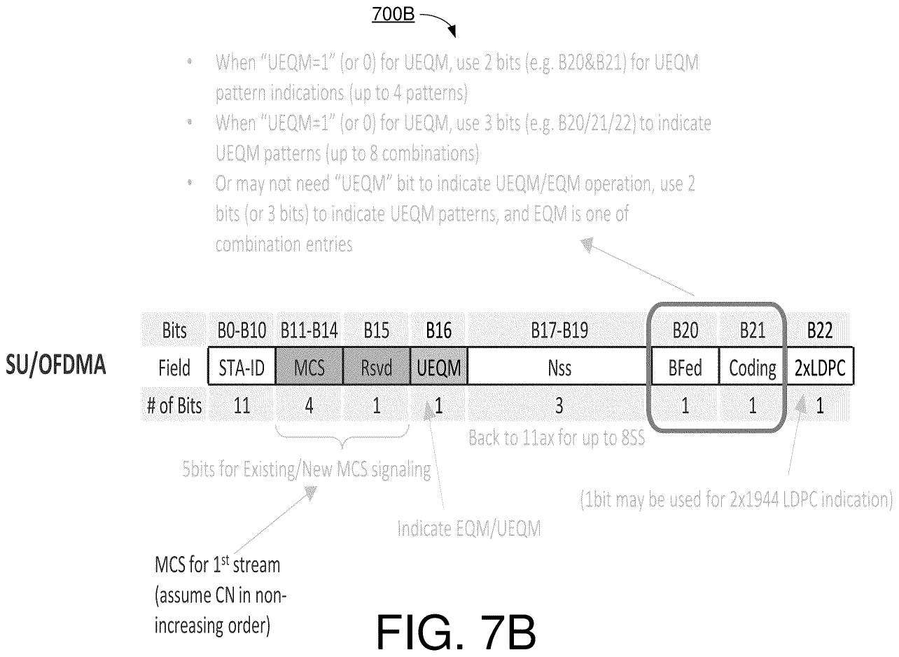

FIG. 7A illustrates an example design 700A under a proposed scheme in accordance with the present disclosure. Design 700A may pertain to a UEQM signaling design which may be applied to SU-MIMO and non-MU-MIMO OFDMA transmissions. Under the proposed scheme, a signaling may be per user and may be carried in the User field of UHR-SIG. Specifically, 5 bits may be utilized for MCS indication. One bit (e.g., bit B19) may be used to indicate EQM or UEQM transmission, additional two bits (e.g., bits B20 and B21, in case of UEQM) may be used to indicate a 2-bit UEQM pattern (e.g., that shown in part (A) of FIG. 6) or additional three bits may be used to indicate a 3-bit UEQM pattern. Alternatively, two (or three) bits may be used to indicate an EQM and UEQM combination pattern (e.g., EQM may be one combination entry). Moreover, one bit (e.g., bit B22) may be used for 2x1944 LDPC indication. Referring to FIG. 7A, MCS in the UHR-SIG User field (e.g., 5 bits) may indicate the MCS (both QAM and coding rate) used in the 1^{st} SS (or the spatial stream with the strongest signal quality). Other streams (e.g., 2^{nd} SS, 3^{rd} SS or 4^{th} SS) may always refer to the 1^{st} SS, with the modulation (or QAM) level being 0-level or 1-level or 2-level down (or lower) but with the coding rate being the same as that of the 1^{st} SS.

FIG. 7B illustrates an example design 700B under the proposed scheme. Design 700B may pertain to an alternative UEQM signaling design which may be applied to SU-MIMO and non-MU-MIMO OFDMA transmissions. Under the proposed scheme, a signaling may be per user and may be carried in the User field of UHR-SIG. Specifically, 5 bits may be utilized for MCS indication. One bit (e.g., bit B16) may be used to indicate EQM or UEQM transmission, additional two bits (e.g., bits B20 and B21, in case of UEQM) may be used to indicate a 2-bit UEQM pattern (e.g., that shown in part (A) of FIG. 6) or additional three bits may be used to indicate a 3-bit UEQM pattern. Alternatively, two (or three) bits may be used to indicate an EQM and UEQM combination pattern (e.g., EQM may be one combination entry). Moreover, one bit (e.g., bit B22) may be used for 2x1944 LDPC indication. Referring to FIG. 7B, MCS in the UHR-SIG User field (e.g., 5 bits) may indicate the MCS (both QAM and coding rate) used in the 1^{st} SS. Other streams (e.g., 2^{nd} SS, 3^{rd} SS or 4^{th} SS) may always refer to the 1^{st} SS, with the modulation (or QAM) level being 0-level or 1-level or 2-level down (or lower) but with the coding rate being the same as that of the 1^{st} SS.

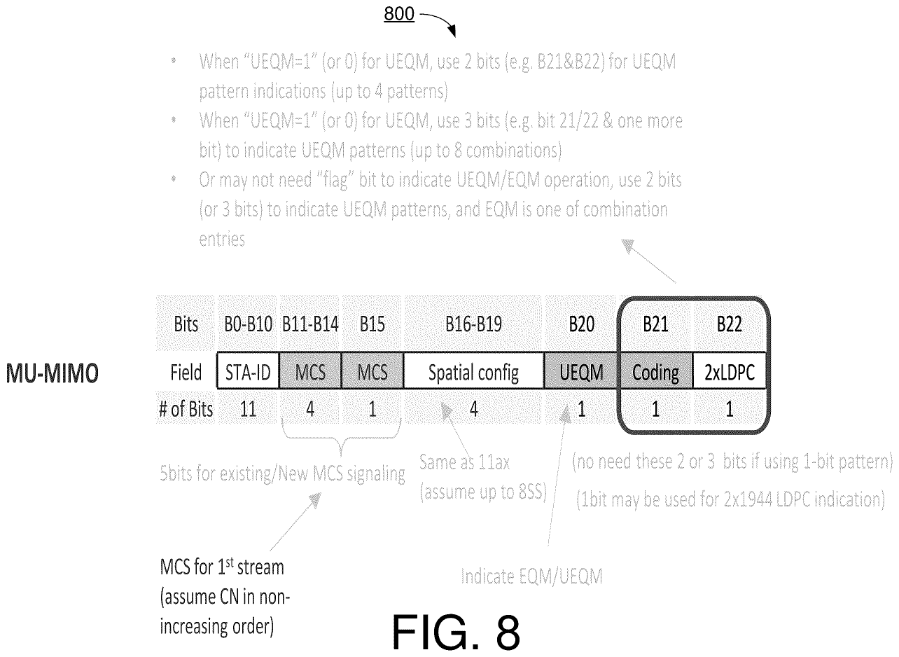

FIG. 8 illustrates an example design 800 under a proposed scheme in accordance with the present disclosure. Design 800 may pertain to a UEQM signaling design which may be applied to non-OFDMA MU-MIMO and OFDMA MU-MIMO transmissions. Under the proposed scheme, a signaling may be per user and may be carried in the User field of UHR-SIG. Specifically, 5 bits may be utilized for MCS indication (for both new MCS and existing MCS). One bit (e.g., bit B20) may be used to indicate EQM or UEQM transmission, additional two bits (e.g., bits B21 and B22, in case of UEQM) may be used to indicate a 2-bit UEQM pattern (e.g., that shown in part (A) of FIG. 6) or additional three bits may be used to indicate a 3-bit UEQM pattern. Alternatively, two (or three) bits may be used to indicate an EQM and UEQM combination pattern (e.g., EQM may be one combination entry). Referring to FIG. 8, MCS in the UHR-SIG User field (e.g., 5 bits) may indicate the MCS (both QAM and coding rate) used in the 1^{st} SS (or the spatial stream with the strongest signal quality). Other streams (e.g., 2^{nd} SS, 3^{rd} SS or 4^{th} SS) may always refer to the 1^{st} SS, with the modulation (or QAM) level being 0-level or 1-level or 2-level down (or lower) but with the coding rate being the same as that of the 1^{st} SS.

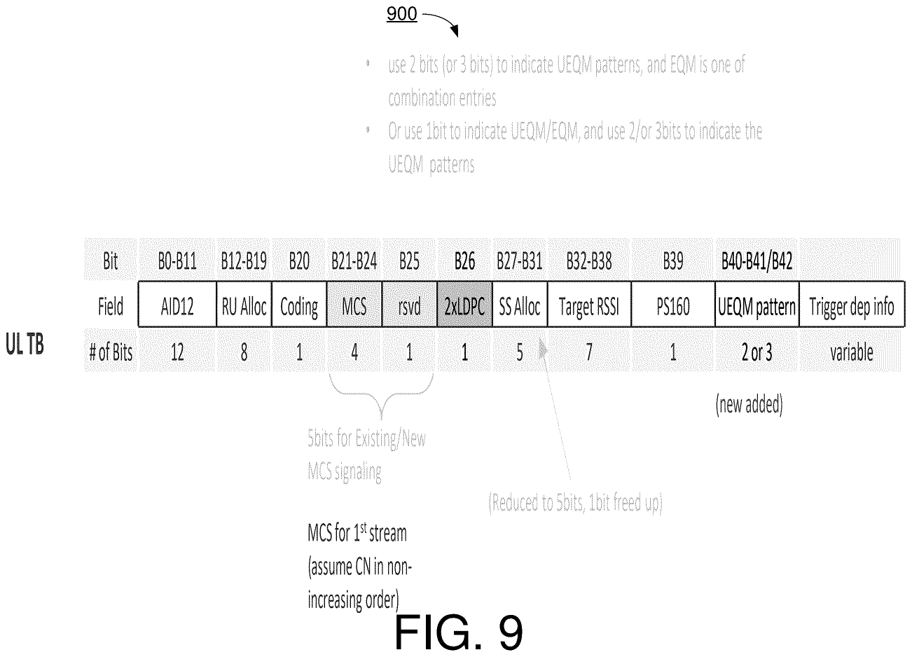

FIG. 9 illustrates an example design 900 under a proposed scheme in accordance with the present disclosure. Design 900 may pertain to a UEQM signaling design which may be applied to UL TB PPDU transmissions. Under the proposed scheme, a signaling may be per user and may be carried in the User field of UHR-SIG. Specifically, 5 bits may be utilized for MCS indication (for both new MCS and existing MCS). One bit may be used to indicate EQM or UEQM transmission, additional two bits may be used to indicate a 2-bit UEQM pattern or additional three bits may be used to indicate a 3-bit UEQM pattern. Alternatively, two (or three) bits may be used to indicate an EQM and UEQM combination pattern (e.g., EQM may be one combination entry). Moreover, one bit (e.g., bit B26) may be used for 2x1944 LDPC indication. Referring to FIG. 9, MCS in the UHR-SIG User field (e.g., 5 bits) may indicate the MCS (both QAM and coding rate) used in the 1^{st} SS. Other streams (e.g., 2^{nd} SS, 3^{rd} SS or 4^{th} SS) may always refer to the 1^{st} SS, with the modulation (or QAM) level being 0-level or 1-level or 2-level down (or lower) but with the coding rate being the same as that of the 1^{st} SS.

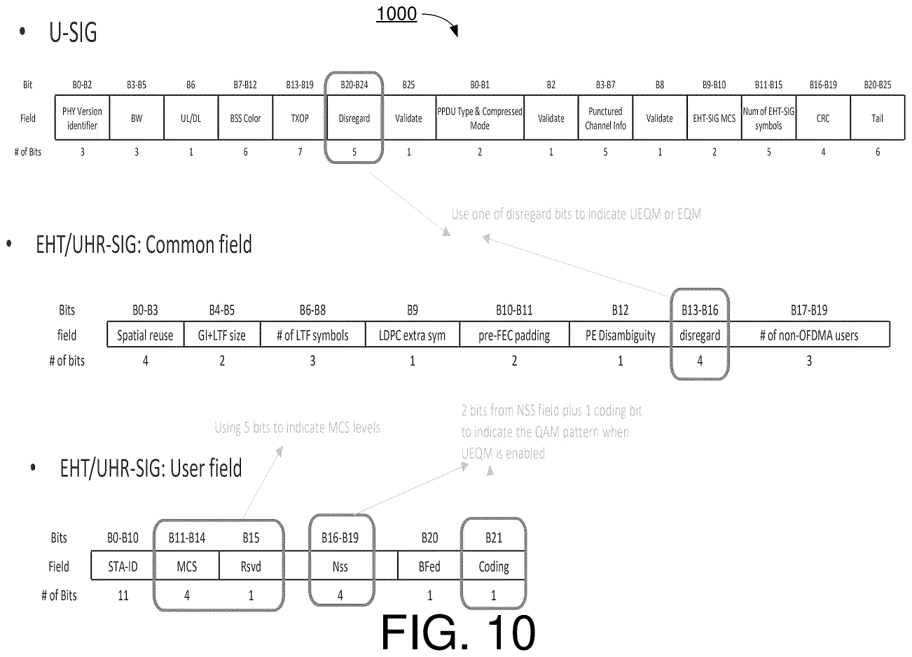

FIG. 10 illustrates an example design 1000 under a proposed scheme in accordance with the present disclosure. Design 1000 may pertain to an alternative UEQM signaling for SU transmissions. Referring to FIG. 10, one bit in a Disregard subfield of a Universal signaling (U-SIG) field and/or EHT/UHR-SIG Common field may be utilized to indicate UEQM or EQM. Moreover, five bits in an MCS subfield and a Reserved subfield of the EHT/UHR-SIG User field may be utilized to indicate MCS levels, and two bits from an Nss (number of spatial streams) subfield plus one bit from a Coding subfield may be utilized to indicate the UEQM pattern when UEQM is enabled.

Under a proposed scheme in accordance with the present disclosure, a first option (Option-1) of alternative UEQM signaling may be utilized for SU transmissions. Under this first option, one bit may be used to indicate “UEQM enabled”, and this UEQM indication bit may be one of the Disregard subfield bits in the U-SIG or Common field of UHR-SIG. In case that the simplified UEQM pattern is used, the signaling may be interpreted in a way described below. For instance, in an event that the value of the UEQM bit=1, then it may indicate “EQM”; and in an event that the value of the UEQM bit=0, then it may indicate “UEQM”. When UEQM is enabled, the MCS in User field may be used to indicate QAM and coding rate for the 1^{st} SS. In case there are two spatial streams (2SS), the 2^{nd} SS may use the same coding rate as the 1^{st} SS but its QAM level may be one level down. In case there are three spatial streams (3SS), the 2^{nd} SS may use the same coding rate and QAM level as the 1^{st} SS, and the 3^{rd} SS may use the same coding rate as the 1^{st} SS but its QAM level may be one level down. In case there are four spatial streams (4SS), the 2^{nd} SS and the 3^{rd} SS may use the same coding rate and QAM level as the 1^{st} SS, and the 4^{th} SS may use the same coding rate as the 1^{st} SS but its QAM level may be two levels down.

Under a proposed scheme in accordance with the present disclosure, a second option (Option-2) of alternative UEQM signaling may be utilized for SU transmissions. Under this second option, one bit may be used to indicate “UEQM enabled”, and this UEQM indication bit may be one of the Disregard subfield bits in the U-SIG or Common field of UHR-SIG. Up to a 2-QAM level difference may be assumed for UEQM. For 2SS, there may be a total of two QAM pattern options. For 3SS, there may be a total of five QAM pattern options. For 4SS, there may be a total of nine QAM pattern options. To simplify signaling, it may be assumed that up to eight QAM pattern options are supported. Moreover, it may be assumed that only LDPC is used with UEQM and that only a number of spatial streams (Nss) supported is up to four for UEQM transmissions. Two of Nss bits may be combined with one Coding bit in the User field, for a total of three bits, to indicate the eight QAM combination patterns. Moreover, when UEQM is enabled, MCS in the User field may be used for the 1^{st} SS and, for 2SS, the 2^{nd} SS may use the same coding rate as the 1^{st} SS.

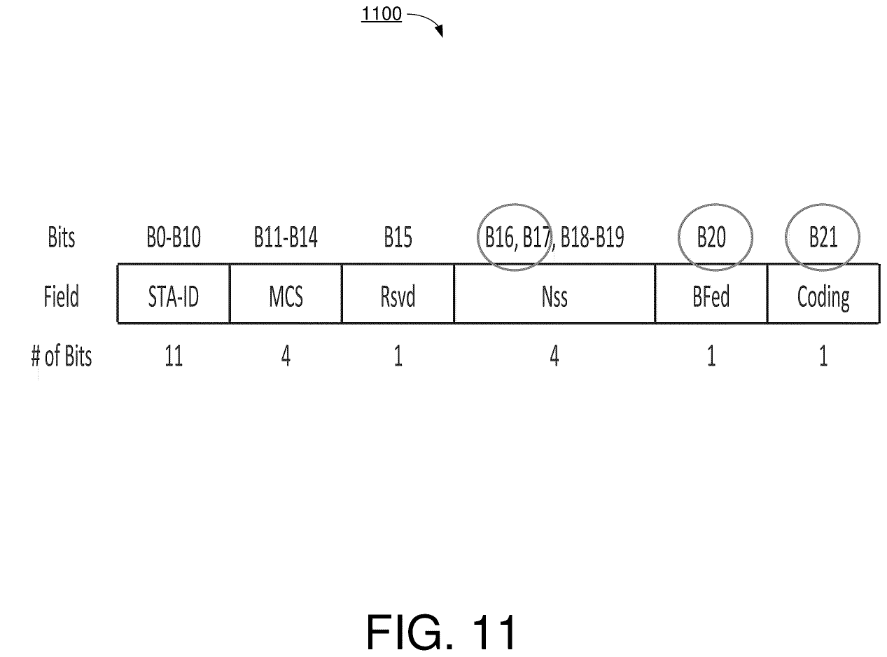

Under a proposed scheme in accordance with the present disclosure, a third option (Option-3) of alternative UEQM signaling may be utilized for SU and OFDMA transmissions. Under this third option, binary combinational coding (BCC) may only be used for Nss≤4. FIG. 11 illustrates an example design 1100 under the proposed scheme. Design 1100 may pertain to the third option of alternative UEQM signaling for SU and OFDMA transmissions. Referring to FIG. 11, bits B16 and B21 may be utilized together to indicate UEQM or EQM. In an event that B16=1 and B21=0, then it may indicate that UEQM is enabled. Bits B18 and B19 may be used to indicate Nss, and bit B17 may be used to indicate the QAM pattern. In case that UEQM is only for beamforming applications, then bits B20 and B17 may together be utilized to indicate up to four QAM patterns. Alternatively, bits B16, B17 and B20 may together be utilized to indicate up to six QAM patterns. Under the proposed scheme, this third option of signaling may be applied to OFDMA with UEQM transmissions.

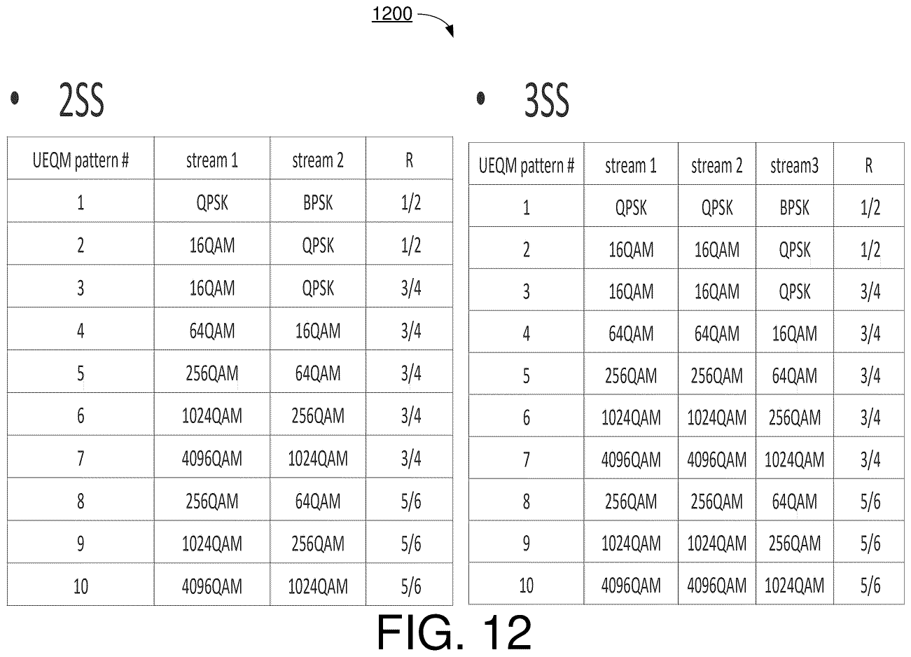

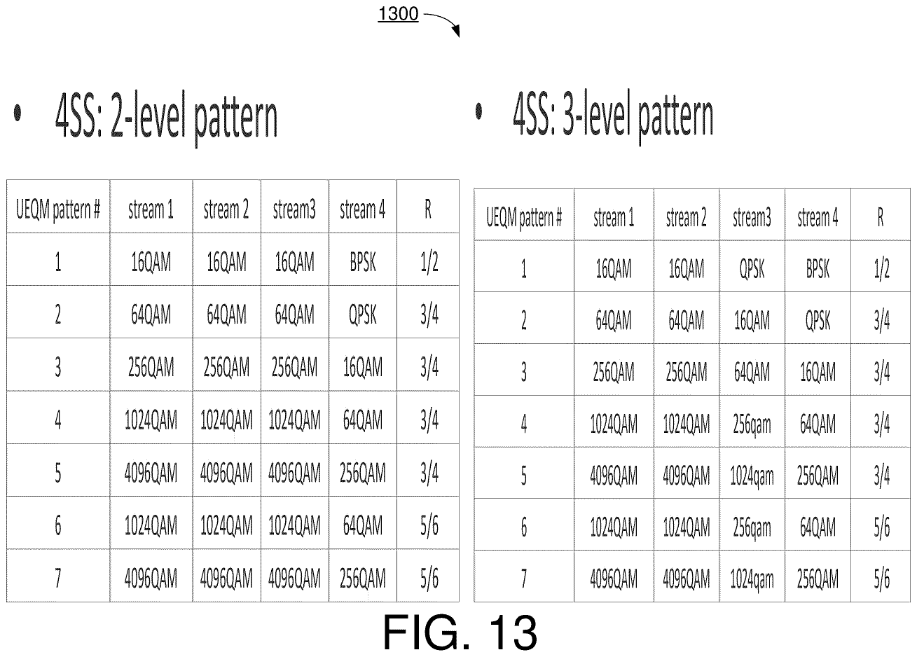

Under a proposed scheme in accordance with the present disclosure, a fourth option (Option-4) of alternative UEQM signaling may be utilized for SU, OFDMA, MU-MIMO and UL TB transmissions. Under this fourth option, MCS defined in the IEEE 802.11be specification may be utilized for UEQM transmissions. Additionally, there may be 1-QAM level difference for 2SS and 3SS. Moreover, this fourth option may utilize predefined 2-level patterns (e.g., QAM/QAM/QAM/QAM-2) or 3-level QAM patterns (e.g., QAM/QAM/QAM-1/QAM-2). FIG. 12 illustrates an example design 1200 under the proposed scheme. FIG. 13 illustrates an example design 1300 under the proposed scheme. Each of design 1200 and design 1300 may pertain to the fourth option of alternative UEQM signaling for SU, OFDMA, MU-MIMO and UL TB transmissions. Referring to FIG. 12 and FIG. 13, each UEQM pattern may be labeled for 2SS, 3SS and 4SS.

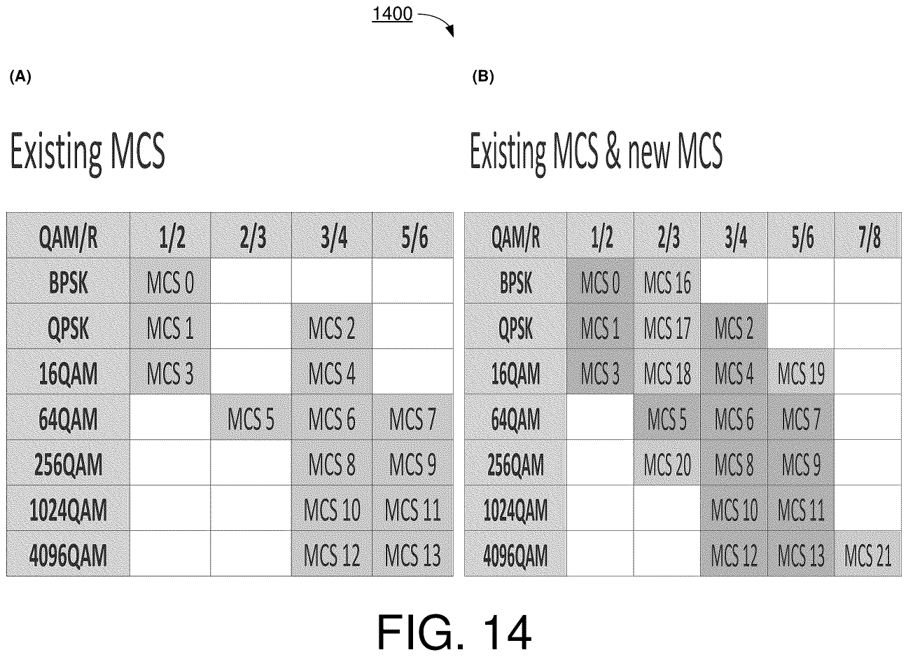

FIG. 14 illustrates an example design 1400 under a proposed scheme in accordance with the present disclosure. Design 1400 may pertain to existing MCS and new MCS defined under the various proposed schemes of the present disclosure. Specifically, part (A) of FIG. 14 shows existing MCS, and part (B) of FIG. 14 shows both the existing MCS and new MCS.

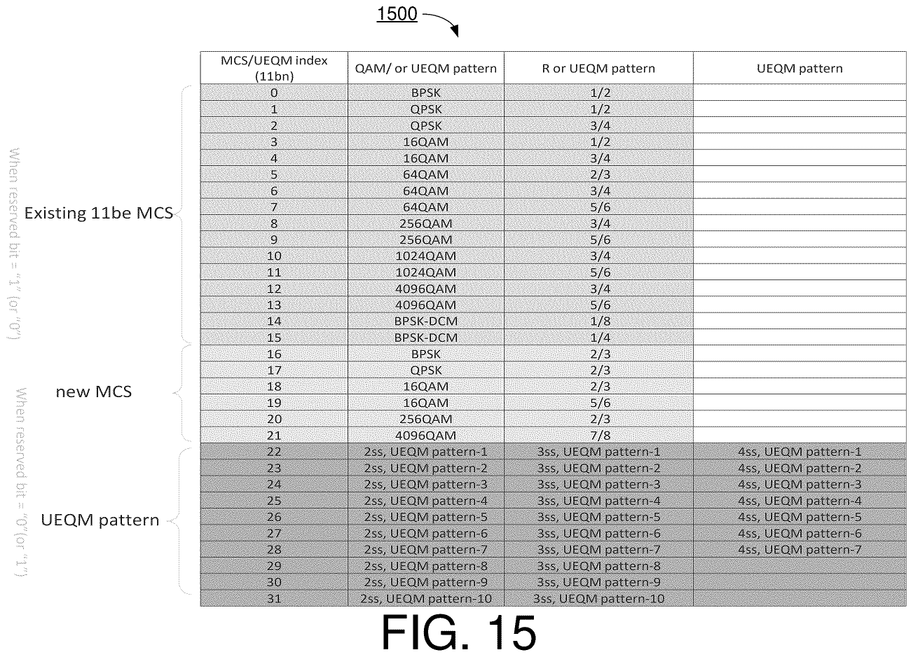

FIG. 15 illustrates an example design 1500 under a proposed scheme in accordance with the present disclosure. Design 1500 may pertain to existing and new MCS and UEQM patterns defined under the various proposed schemes of the present disclosure. For instance, the table in FIG. 15 may be an index table of existing and new MCS and UEQM patterns for IEEE 802.11bn (Wi-Fi 8). Under the proposed scheme, more bits (e.g., six or seven bits) may be utilized to indicate MCS and UEQM pattern indexes.

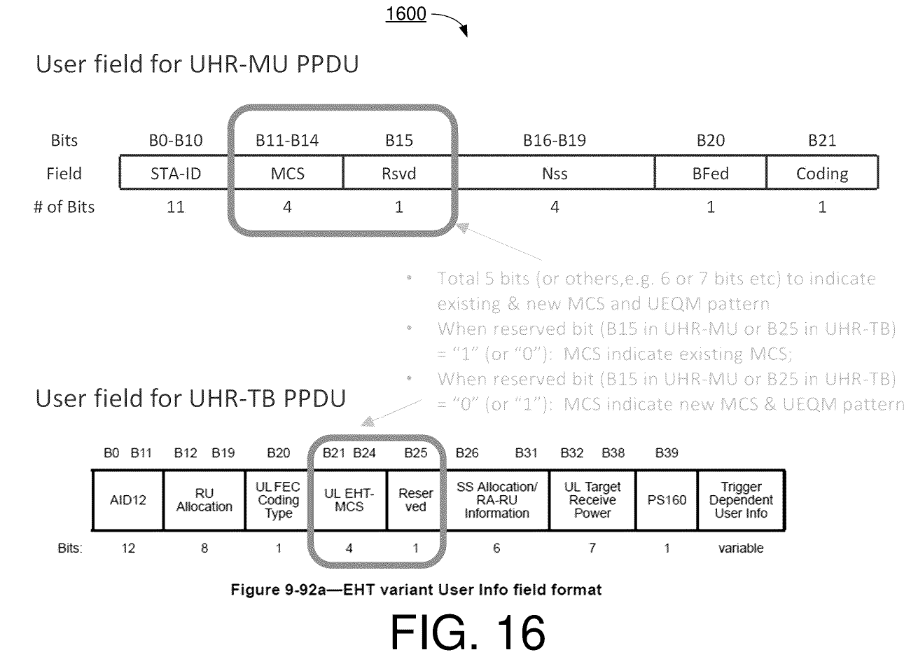

FIG. 16 illustrates an example design 1600 under a proposed scheme in accordance with the present disclosure. Design 1600 may pertain to new MCS and UEQM pattern indication. Under the proposed scheme, five bits (or six or seven bits, or a different number of bits) may be defined for MCS and UEQM pattern indication. This may be utilized in an index table-based method.

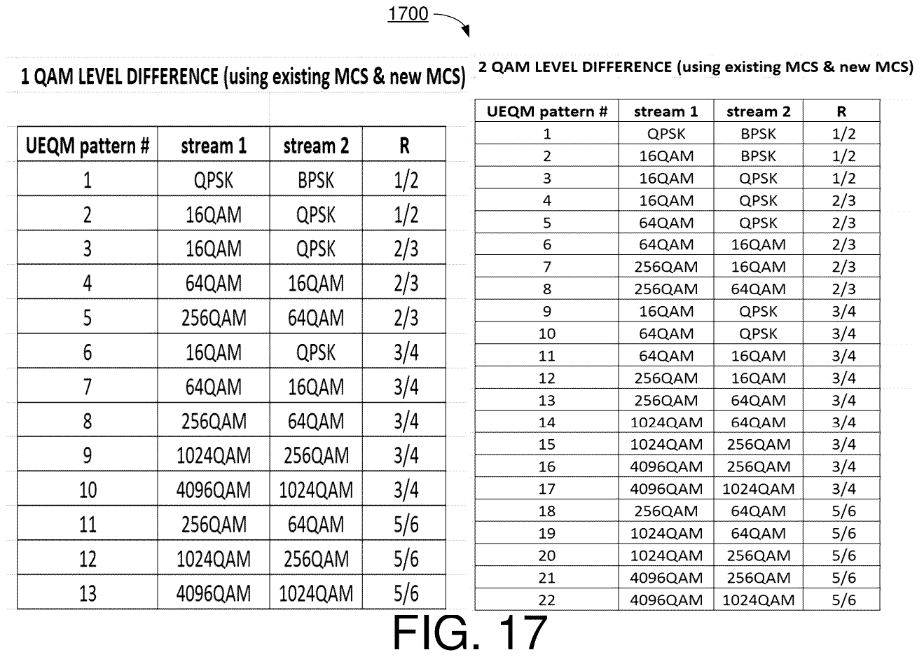

Under a proposed scheme in accordance with the present disclosure, a fifth option (Option-5) of alternative UEQM signaling may be utilized for SU, OFDMA, MU-MIMO and UL TB transmissions. Under this fifth option, MCS defined in the IEEE 802.11be specification, in addition to new MCS, may be utilized for UEQM transmissions. Additionally, there may be 1-QAM level difference for 2SS and 3SS. Moreover, this fourth option may utilize predefined 2-level patterns (e.g., QAM/QAM/QAM/QAM-2) or 3-level UEQM patterns (e.g., QAM/QAM/QAM-1/QAM-2). FIG. 17 illustrates an example design 1700 under the proposed scheme. Design 1700 may pertain to the fourth option of alternative UEQM signaling for SU, OFDMA, MU-MIMO and UL TB transmissions. Referring to FIG. 17, each UEQM pattern may be labeled for 2SS, 3SS and 4SS.

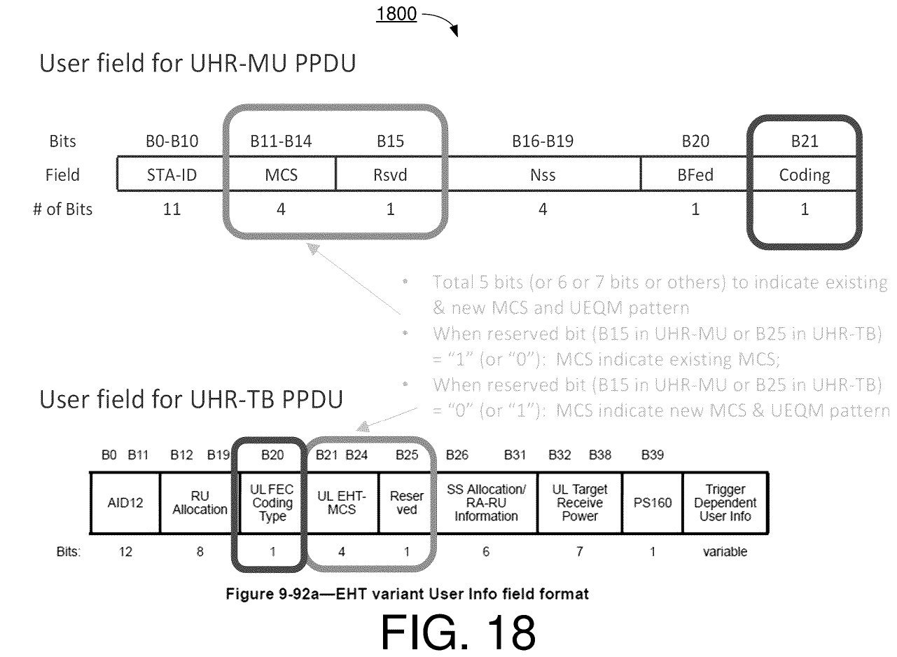

FIG. 18 illustrates an example design 1800 under a proposed scheme in accordance with the present disclosure. Design 1800 may pertain to new MCS and UEQM pattern indication. Under the proposed scheme, five bits (or six or seven bits, or a different number of bits) may be defined for MCS and UEQM pattern indication. The Coding subfield may be used to indicate more UEQM patterns.

### Illustrative Implementations

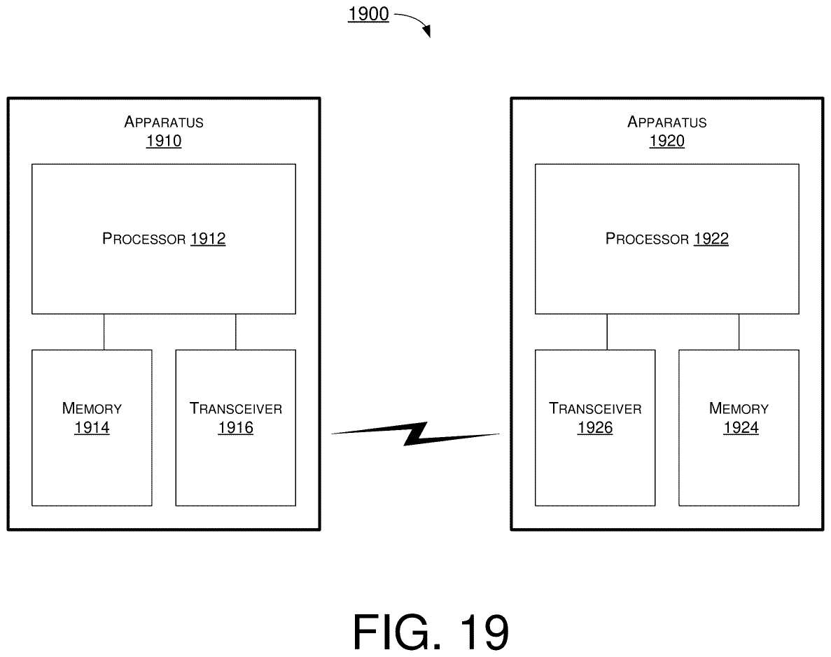

FIG. 19 illustrates an example system 1900 having at least an example apparatus 1910 and an example apparatus 1920 in accordance with an implementation of the present disclosure. Each of apparatus 1910 and apparatus 1920 may perform various functions to implement schemes, techniques, processes and methods described herein pertaining to signaling designs to enable UEQM transmission on spatial streams in wireless communications including the various schemes described above with respect to various proposed designs, concepts, schemes, systems and methods described above as well as processes described below. For instance, apparatus 1910 may be implemented in STA 110 and apparatus 1920 may be implemented in STA 120, or vice versa.

Each of apparatus 1910 and apparatus 1920 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1910 and apparatus 1920 may be implemented in a smartphone, a smart watch, a personal digital assistant, a digital camera, or a computing equipment such as a tablet computer, a laptop computer or a notebook computer. Each of apparatus 1910 and apparatus 1920 may also be a part of a machine type apparatus, which may be an IoT apparatus such as an immobile or a stationary apparatus, a home apparatus, a wire communication apparatus or a computing apparatus. For instance, each of apparatus 1910 and apparatus 1920 may be implemented in a smart thermostat, a smart fridge, a smart door lock, a wireless speaker or a home control center. When implemented in or as a network apparatus, apparatus 1910 and/or apparatus 1920 may be implemented in a network node, such as an AP in a WLAN.

In some implementations, each of apparatus 1910 and apparatus 1920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1910 and apparatus 1920 may be implemented in or as a STA or an AP. Each of apparatus 1910 and apparatus 1920 may include at least some of those components shown in FIG. 19 such as a processor 1912 and a processor 1922, respectively, for example. Each of apparatus 1910 and apparatus 1920 may further include one or more other components not pertinent to the proposed scheme of the present disclosure (e.g., internal power supply, display device and/or user interface device), and, thus, such component(s) of apparatus 1910 and apparatus 1920 are neither shown in FIG. 19 nor described below in the interest of simplicity and brevity.

In one aspect, each of processor 1912 and processor 1922 may be implemented in the form of one or more single-core processors, one or more multi-core processors, one or more RISC processors or one or more CISC processors. That is, even though a singular term “a processor” is used herein to refer to processor 1912 and processor 1922, each of processor 1912 and processor 1922 may include multiple processors in some implementations and a single processor in other implementations in accordance with the present disclosure. In another aspect, each of processor 1912 and processor 1922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1912 and processor 1922 is a special-purpose machine specifically designed, arranged and configured to perform specific tasks including those pertaining to signaling designs to enable UEQM transmission on spatial streams in wireless communications in accordance with various implementations of the present disclosure.

In some implementations, apparatus 1910 may also include a transceiver 1916 coupled to processor 1912. Transceiver 1916 may include a transmitter capable of wirelessly transmitting and a receiver capable of wirelessly receiving data. In some implementations, apparatus 1920 may also include a transceiver 1926 coupled to processor 1922. Transceiver 1926 may include a transmitter capable of wirelessly transmitting and a receiver capable of wirelessly receiving data. It is noteworthy that, although transceiver 1916 and transceiver 1926 are illustrated as being external to and separate from processor 1912 and processor 1922, respectively, in some implementations, transceiver 1916 may be an integral part of processor 1912 as a system on chip (SoC), and transceiver 1926 may be an integral part of processor 1922 as a SoC.

In some implementations, apparatus 1910 may further include a memory 1914 coupled to processor 1912 and capable of being accessed by processor 1912 and storing data therein. In some implementations, apparatus 1920 may further include a memory 1924 coupled to processor 1922 and capable of being accessed by processor 1922 and storing data therein. Each of memory 1914 and memory 1924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1914 and memory 1924 may include a type of read-only memory (ROM) such as mask ROM, programmable ROM (PROM), erasable programmable ROM (EPROM) and/or electrically erasable programmable ROM (EEPROM). Alternatively, or additionally, each of memory 1914 and memory 1924 may include a type of non-volatile random-access memory (NVRAM) such as flash memory, solid-state memory, ferroelectric RAM (FeRAM), magnetoresistive RAM (MRAM) and/or phase-change memory.

Each of apparatus 1910 and apparatus 1920 may be a communication entity capable of communicating with each other using various proposed schemes in accordance with the present disclosure. For illustrative purposes and without limitation, a description of capabilities of apparatus 1910, as STA 110, and apparatus 1920, as STA 120, is provided below in the context of example process 2000. It is noteworthy that, although a detailed description of capabilities, functionalities and/or technical features of apparatus 1920 is provided below, the same may be applied to apparatus 1910 although a detailed description thereof is not provided solely in the interest of brevity. It is also noteworthy that, although the example implementations described below are provided in the context of WLAN, the same may be implemented in other types of networks.

### Illustrative Processes

FIG. 20 illustrates an example process 2000 in accordance with an implementation of the present disclosure. Process 2000 may represent an aspect of implementing various proposed designs, concepts, schemes, systems and methods described above. More specifically, process 2000 may represent an aspect of the proposed concepts and schemes pertaining to signaling designs to enable UEQM transmission on spatial streams in wireless communications in accordance with the present disclosure. Process 2000 may include one or more operations, actions, or functions as illustrated by one or more of blocks 2010 and subblocks 2020 and 2030. Although illustrated as discrete blocks, various blocks of process 2000 may be divided into additional blocks, combined into fewer blocks, or eliminated, depending on the desired implementation. Moreover, the blocks/sub-blocks of process 2000 may be executed in the order shown in FIG. 20 or, alternatively, in a different order. Furthermore, one or more of the blocks/sub-blocks of process 2000 may be executed repeatedly or iteratively. Process 2000 may be implemented by or in apparatus 1910 and apparatus 1920 as well as any variations thereof. Solely for illustrative purposes and without limiting the scope, process 2000 is described below in the context of apparatus 1910 implemented in or as STA 110 functioning as a non-AP STA or an AP STA and apparatus 1920 implemented in or as STA 120 functioning as an AP STA or a non-AP STA of a wireless network such as a WLAN in network environment 100 in accordance with one or more of IEEE 802.11 standards. Process 2000 may begin at block 2010.

At 2010, process 2000 may involve processor 1912 of apparatus 1910 performing, via transceiver 1916, a wireless communication with a PPDU. The wireless communication may be performed with signaling indicating information of UEQM over multiple spatial streams with respect to a transmission of the PPDU. The wireless communication may involve operations represented by 2020 or 2030. Process 2000 may proceed from 2010 to 2020 or 2030.

At 2020, process 2000 may involve processor 1912 generating and transmitting the PPDU (e.g., to apparatus 1920 as STA 120).

At 2030, process 2000 may involve processor 1912 receiving and processing the PPDU (e.g., from apparatus 1920 as STA 120).

In some implementations, in performing the wireless communication, process 2000 may involve processor 1912 performing the wireless communication with the PPDU transmitted with the UEQM on the multiple spatial streams in a SU-MIMO mode, an OFDMA mode, a MU-MIMO mode or an UL TB mode.

In some implementations, the signaling may indicate whether or not the UEQM is enabled and an UEQM pattern over the multiple spatial streams.

In some implementations, the signaling may indicate an MCS level of the transmission of the PPDU as one of: (a) a BPSK with a 2/3 coding rate; (b) a QPSK with the 2/3 coding rate; (c) a 16QAM with the 2/3 coding rate; (d) a 16QAM with a 5/6 coding rate; (e) a 256QAM with the 2/3 coding rate; (f) a 4096QAM with a 7/8 coding rate, and (g) an existing MCS defined in an IEEE 802.11bn specification.

In some implementations, the signaling may be per-user and is included in a User field of an UHR-SIG field of the PPDU.

In some implementations, responsive to the transmission of the PPDU is performed with the UEQM, coding and decoding of the PPDU may be performed with LDPC only.

In some implementations, the signaling may include 5 bits in a User field of an UHR-SIG field of the PPDU indicating an MCS information with respect to the transmission of the PPDU.

In some implementations, the multiple spatial streams may include at least a first spatial stream (1SS) and a second spatial stream (2SS). Moreover, the MCS information with respect to the 1SS may include a QAM level or order and a coding rate used on the 1SS. Furthermore, the MCS information with respect to the 2SS may refer to the QAM level or order of the 1SS as being 0-level, 1-level or 2-level down or lower from that of the 1SS, and wherein the 1SS and 2SS have a same coding rate.

In some implementations, whether or not the UEQM is enabled may be indicated with 1 bit, an UEQM pattern may be indicated with another 2 bits in a User field of the UHR-SIG field, and a Beamformed bit and a Coding bit in the User field of the UHR-SIG field may be re-purposed for the UEQM pattern indication when the UEQM is enabled.

In some implementations, the UEQM pattern may include a 2-QAM level difference between one spatial stream of the multiple spatial streams and another spatial stream of the multiple spatial streams.

In some implementations, the multiple spatial streams may include a 1SS and a 2SS such that: (a) the 1SS has a modulation level of QAM and the 2SS has a modulation level or order that is 1 level down or lower than QAM (QAM-1); or (b) the 1SS has the modulation level or order of QAM and the 2SS has a modulation level or order that is 2 levels down or lower than QAM (QAM-2).

In some implementations, the multiple spatial streams may include a 1SS, a 2SS and a 3SS (third spatial stream) such that: (a) the 1SS has a modulation level or order of QAM, the 2SS has a same modulation level or order as QAM, and the 3SS has a modulation level or order that is 1 level down or lower than QAM (QAM-1); (b) the 1SS has the modulation level or order of QAM, the 2SS has the same modulation level or order as QAM, and the 3SS has a modulation level or order that is 2 levels down or lower than QAM (QAM-2); or (c) the 1SS has the modulation level or order of QAM, the 2SS has the modulation level or order that is 1 level down or lower than QAM (QAM-1), and the 3SS has the modulation level or order that is 2 levels down or lower than QAM (QAM-2).

In some implementations, the multiple spatial streams may include a 1SS, a 2SS, a 3SS and a 4SS (the fourth spatial stream) such that: (a) the 1SS has a modulation level of QAM, the 2SS has a same modulation level or order as QAM, the 3SS has the same modulation level or order as QAM, and the 4SS has a modulation level or order that is 1 level down or lower than QAM (QAM-1); (b) the 1SS has a modulation level or order of QAM, the 2SS has the same modulation level or order as QAM, the 3SS has the same modulation level or order as QAM, and the 4SS has a modulation level or order that is 2 levels down or lower than QAM (QAM-2); (c) the 1SS has a modulation level or order of QAM, the 2SS has a same modulation level or order as QAM, the 3SS has the modulation level or order that is 1 level down or lower than QAM (QAM-1), and the 4SS has the modulation level or order that is 2 level down or lower than QAM (QAM-2); or (d) the 1SS has a modulation level or order of QAM, the 2SS has a modulation level or order that is 1 level down or lower than QAM (QAM-1), the 3SS has the modulation level or order that is 1 level down or lower than QAM (QAM-1), and the 4SS has the modulation level or order that is 2 levels down or lower than QAM (QAM-2).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a wireless communication with a physical-layer protocol data unit (PPDU) by either:
generating and transmitting the PPDU; or
receiving and processing the PPDU,
wherein the wireless communication is performed with signaling indicating information of unequal modulation (UEQM) over multiple spatial streams with respect to a transmission of the PPDU.

2. The method of claim 1, wherein the performing of the wireless communication comprises performing the wireless communication with the PPDU transmitted with the UEQM on the multiple spatial streams in a single-user multi-input-multi-output (SU-MIMO) mode, an orthogonal frequency-division multiple-access (OFDMA) mode, a multi-user multi-input-multi-output (MU-MIMO) mode or an uplink trigger-based (UL TB) mode.

3. The method of claim 1, wherein the signaling indicates whether or not the UEQM is enabled and an UEQM pattern over the multiple spatial streams.

4. The method of claim 1, wherein the signaling indicates a modulation and coding scheme (MCS) level of the transmission of the PPDU as one of:
an existing MCS defined in an Institute of Electrical and Electronics Engineers (IEEE) 802.11bn specification;
a binary phase shift keying (BPSK) with a 2/3 coding rate;
a quadrature phase shift keying (QPSK) with the 2/3 coding rate;
a 16 quadrature amplitude modulation (16QAM) with the 2/3 coding rate or a 5/6 coding rate;
a 256 quadrature amplitude modulation (256QAM) with the 2/3 coding rate; and
a 4096 quadrature amplitude modulation (4096QAM) with a 7/8 coding rate.

5. The method of claim 1, wherein the signaling is per-user and is included in a User field of an Ultra-High-Reliability Signaling (UHR-SIG) field of the PPDU.

6. The method of claim 1, wherein, responsive to the transmission of the PPDU is performed with the UEQM, coding and decoding of the PPDU is performed with low-density parity-check (LDPC) only.

7. The method of claim 1, wherein the signaling comprises 5 bits in a User field of an Ultra-High-Reliability Signaling (UHR-SIG) field of the PPDU indicating a modulation and coding scheme (MCS) information with respect to the transmission of the PPDU.

8. The method of claim 7, wherein the multiple spatial streams comprise at least a first spatial stream (1SS) and a second spatial stream (2SS), wherein the MCS information with respect to the 1SS comprises a quadrature amplitude modulation (QAM) level or order and a coding rate used on the 1SS, wherein the MCS information with respect to the 2SS refers to the modulation level or order of the 1SS as being 0-level, 1-level or 2-level down or lower from that of the 1SS, and wherein the 1SS and 2SS have a same coding rate.

9. The method of claim 7, wherein whether or not the UEQM is enabled is indicated with 1 bit, wherein an UEQM pattern is indicated with another 2 bits in a User field of the UHR-SIG field, and wherein a Beamformed bit and a Coding bit in the User field of the UHR-SIG field are re-purposed for the UEQM pattern indication when the UEQM is enabled.

10. The method of claim 9, wherein the UEQM pattern comprises a 2-modulation level or order difference between one spatial stream of the multiple spatial streams and another spatial stream of the multiple spatial streams, and wherein the multiple spatial streams comprises a first spatial stream (1SS) and a second spatial stream (2SS) such that:
the 1SS has a modulation level or order of QAM and the 2SS has a modulation level or order that is 1 level down or lower than QAM (QAM-1); or
the 1SS has the modulation level or order of QAM and the 2SS has a modulation level that is 2 levels down or lower than QAM (QAM-2).

11. The method of claim 9, wherein the UEQM pattern comprises a 2-modulation level or order difference between one spatial stream of the multiple spatial streams and another spatial stream of the multiple spatial streams, and wherein the multiple spatial streams comprises a first spatial stream (1SS), a second spatial stream (2SS) and a third spatial stream (3SS) such that:
the 1SS has a modulation level or order of QAM, the 2SS has a same modulation level or order as QAM, and the 3SS has a modulation level or order that is 1 level down or lower than QAM (QAM-1);
the 1SS has the modulation level or order of QAM, the 2SS has the same modulation level or order as QAM, and the 3SS has a modulation level or order that is 2 levels down or lower than QAM (QAM-2); or
the 1SS has the modulation level or order of QAM, the 2SS has the modulation level or order that is 1 level down or lower than QAM (QAM-1), and the 3SS has the modulation level or order that is 2 levels down or lower than QAM (QAM-2).

12. The method of claim 9, wherein the UEQM pattern comprises a 2-modulation level or order difference between one spatial stream of the multiple spatial streams and another spatial stream of the multiple spatial streams, and wherein the multiple spatial streams comprises a first spatial stream (1SS), a second spatial stream (2SS), a third spatial stream (3SS) and a fourth spatial stream (4SS) such that:
the 1SS has a modulation level or order of QAM, the 2SS has a same modulation level or order as QAM, the 3SS has the same modulation level or order as QAM, and the 4SS has a modulation level or order that is 1 level down or lower than QAM (QAM-1);
the 1SS has a modulation level or order of QAM, the 2SS has the same modulation level or order as QAM, the 3SS has the same modulation level or order as QAM, and the 4SS has a modulation level or order that is 2 levels down or lower than QAM (QAM-2);
the 1SS has a modulation level or order of QAM, the 2SS has a same modulation level or order as QAM, the 3SS has the modulation level or order that is 1 level down or lower than QAM (QAM-1), and the 4SS has the modulation level or order that is 2 level down or lower than QAM (QAM-2); or
the 1SS has a modulation level or order of QAM, the 2SS has a modulation level or order that is 1 level down or lower than QAM (QAM-1), the 3SS has the modulation level or order that is 1 level down or lower than QAM (QAM-1), and the 4SS has the modulation level or order that is 2 levels down or lower than QAM (QAM-2).

13. An apparatus, comprising:
a transceiver configured to communicate wirelessly; and
a processor coupled to the transceiver and configured to perform operations comprising:
performing, via the transceiver, a wireless communication with a physical-layer protocol data unit (PPDU) by either:
generating and transmitting the PPDU; or
receiving and processing the PPDU,
wherein the wireless communication is performed with signaling indicating information of unequal modulation (UEQM) over multiple spatial streams with respect to a transmission of the PPDU.

14. The apparatus of claim 13, wherein the performing of the wireless communication comprises performing the wireless communication with the PPDU transmitted with the UEQM on the multiple spatial streams in a single-user multi-input-multi-output (SU-MIMO) mode, an orthogonal frequency-division multiple-access (OFDMA) mode, a multi-user multi-input-multi-output (MU-MIMO) mode or an uplink trigger-based (UL TB) mode.

15. The apparatus of claim 13, wherein the signaling indicates whether or not the UEQM is enabled and an UEQM pattern over the multiple spatial streams, wherein the signaling is per-user and is included in a User field of the PPDU, and wherein, responsive to the transmission of the PPDU is performed with the UEQM, coding and decoding of the PPDU is performed with low-density parity-check (LDPC) only.

16. The apparatus of claim 13, wherein the signaling indicates a modulation and coding scheme (MCS) level of the transmission of the PPDU as one of:
an existing MCS defined in an Institute of Electrical and Electronics Engineers (IEEE) 802.11bn specification;
a binary phase shift keying (BPSK) with a 2/3 coding rate;
a quadrature phase shift keying (QPSK) with the 2/3 coding rate;
a 16 quadrature amplitude modulation (16QAM) with the 2/3 coding rate or a 5/6 coding rate;
a 256 quadrature amplitude modulation (256QAM) with the 2/3 coding rate; and
a 4096 quadrature amplitude modulation (4096QAM) with a 7/8 coding rate.

17. The apparatus of claim 13, wherein the signaling comprises 5 bits in a User field of an Ultra-High-Reliability Signaling (UHR-SIG) field of the PPDU indicating a modulation and coding scheme (MCS) information with respect to the transmission of the PPDU, and wherein whether or not the UEQM is enabled is indicated with 1 bit, wherein an UEQM pattern is indicated with another 2 bits in a User field of a Ultra-High-Reliability Signaling (UHR-SIG) field, and wherein a Beamformed bit and a Coding bit in the User field of the UHR-SIG field are re-purposed for the UEQM pattern indication when the UEQM is enabled.

18. The apparatus of claim 17, wherein the UEQM pattern comprises a 2-QAM level or order difference between one spatial stream of the multiple spatial streams and another spatial stream of the multiple spatial streams, and wherein the multiple spatial streams comprises a first spatial stream (1SS) and a second spatial stream (2SS) such that:
the 1SS has a modulation level or order of QAM and the 2SS has a modulation level or order that is 1 level down or lower than QAM (QAM-1); or
the 1SS has the modulation level or order of QAM and the 2SS has a modulation level or order that is 2 levels down or lower than QAM (QAM-2).

19. The apparatus of claim 17, wherein the UEQM pattern comprises a 2-QAM level or order difference between one spatial stream of the multiple spatial streams and another spatial stream of the multiple spatial streams, and wherein the multiple spatial streams comprises a first spatial stream (1SS), a second spatial stream (2SS) and a third spatial stream (3SS) such that:
the 1SS has a modulation level or order of QAM, the 2SS has a same modulation level or order as QAM, and the 3SS has a modulation level or order that is 1 level down or lower than QAM (QAM-1);
the 1SS has the modulation level or order of QAM, the 2SS has the same modulation level or order as QAM, and the 3SS has a modulation level or order that is 2 levels down or lower than QAM (QAM-2); or
the 1SS has the modulation level or order of QAM, the 2SS has the modulation level or order that is 1 level down or lower than QAM (QAM-1), and the 3SS has the modulation level or order that is 2 levels down or lower than QAM (QAM-2).

20. The apparatus of claim 17, wherein the UEQM pattern comprises a 2-QAM level or order difference between one spatial stream of the multiple spatial streams and another spatial stream of the multiple spatial streams, and wherein the multiple spatial streams comprises a first spatial stream (1SS), a second spatial stream (2SS), a third spatial stream (3SS) and a fourth spatial stream (4SS) such that:
the 1SS has a modulation level or order of QAM, the 2SS has a same modulation level or order as QAM, the 3SS has the same modulation level or order as QAM, and the 4SS has a modulation level or order that is 1 level down or lower than QAM (QAM-1);
the 1SS has a modulation level or order of QAM, the 2SS has the same modulation level or order as QAM, the 3SS has the same modulation level or order as QAM, and the 4SS has a modulation level or order that is 2 levels down or lower than QAM (QAM-2);
the 1SS has a modulation level or order of QAM, the 2SS has a same modulation level or order as QAM, the 3SS has the modulation level or order that is 1 level down or lower than QAM (QAM-1), and the 4SS has the modulation level or order that is 2 level down or lower than QAM (QAM-2); or
the 1SS has a modulation level or order of QAM, the 2SS has a modulation level or order that is 1 level down or lower than QAM (QAM-1), the 3SS has the modulation level or order that is 1 level down or lower than QAM (QAM-1), and the 4SS has the modulation level or order that is 2 levels down or lower than QAM (QAM-2).
